(19) United States
(12) Patent Application Publication
(10) Pub. No.: US 2012/0023753 A1
(43) Pub. Date: Feb. 2, 2012

(54) KNIFE HAVING A LOCKING MECHANISM

(76) Inventor: Hao Wen, City of Industry, CA (US)

(21) Appl. No.: 12/848,725

(22) Filed: Aug. 2, 2010

(51) Int. Cl. B26B 1/04; B26B 5/00

(52) U.S. Cl. 30/156; 30/161

(57) ABSTRACT

A method and apparatus for a knife having a handle, a blade and a locking mechanism whereby the mechanism provides a pivot point between the handle and blade holder and at least two selective locking positions between the blade and the handle. In one embodiment the knife is a utility knife including a blade holder that houses the blade and pivots with the blade relative to the handle.

### BACKGROUND OF THE INVENTION

1. Field of the Invention

Embodiments of the present invention generally relate to a locking mechanism for a knife. More particularly, the invention relates to a locking mechanism for a utility knife wherein a blade and blade holder of the knife may be rotationally locked in any one of several predetermined positions relative to the handle.

2. Description of the Related Art

A conventional folding knife includes a blade and a handle. In the case of a utility knife, the blade is retained in a blade holder that rotates around a pivot point relative to the handle. The blade holder in the conventional folding utility knife typically includes two positions, an opened position and a closed position. In the closed position, a portion of the blade holder is positioned in the handle such that a cutting edge of the blade in the blade is protected.

The conventional folding utility knife may include a lock mechanism to lock the blade holder in a position relative to the handle, typically the opened position to prevent accidently movement of the blade during use. Even though the conventional folding utility knife may be locked in the opened position, there is a need for an inter-lock mechanism for use with the folding utility knife that is capable of locking the blade holder in an opened position, a closed position and any number of intermediate positions in order to take full advantage of the various uses of a knife, especially a utility knife.

### SUMMARY OF THE INVENTION

The present invention generally relates to a knife having a handle, a blade and a locking mechanism, providing a pivot point between the handle and blade holder as well as at least two selective locking positions between the blade and the handle. In one embodiment the knife is a utility knife including a blade holder that houses the blade and pivots with the blade relative to the handle.

In another embodiment, the locking mechanism includes a lock button a lock button that extends through the handle and blade holder to form a pivot point between the handle and blade holder and the lock button provides at least two selective locking positions between the blade holder and the handle.

In yet another embodiment, a method is provided that includes depressing a spring-biased lock button on a first side of the knife, thereby causing a blade locking formation to be displaced from engagement with a first blade locking groove in a blade holder, and rotating the blade holder from a first rotational position relative to a handle, to a second rotational position relative to the handle whereby, in the second rotational position, the blade locking formation becomes engaged with a second blade locking groove.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a utility knife having embodiments of the present invention.

FIG. 2 is an exploded view of the knife of FIG. 1.

FIG. 3 is an enlarged view of a second portion of a lock button.

FIG. 4 illustrates the connection between a first and second portions of the lock button.

FIG. 5 is a view illustrating one handle portion of the knife having an aperture formed therein with radially extending groves extending from the aperture.

FIG. 6 illustrates a blade and blade holder with an aperture formed in the blade holder with blade locking grooves extending radially outward therefrom.

FIG. 7 is a section view showing the lock button, handle and blade holder with the blade holder locked in a predetermined rotational position relative to the handle.

FIG. 8 is a section view showing the lock button, handle and blade holder with the blade holder free to rotate about a pivot point formed about the lock button.

FIGS. 9 and 10 are side views of one handle portion showing a blade locking formation in a locked (FIG. 9) and unlocked position relative to the blade holder (not shown).

FIGS. 11-14 are partial section views showing the knife in various locked positions and illustrating the location of the blade locking formation disposed in various blade locking grooves of the blade holder.

### DETAILED DESCRIPTION

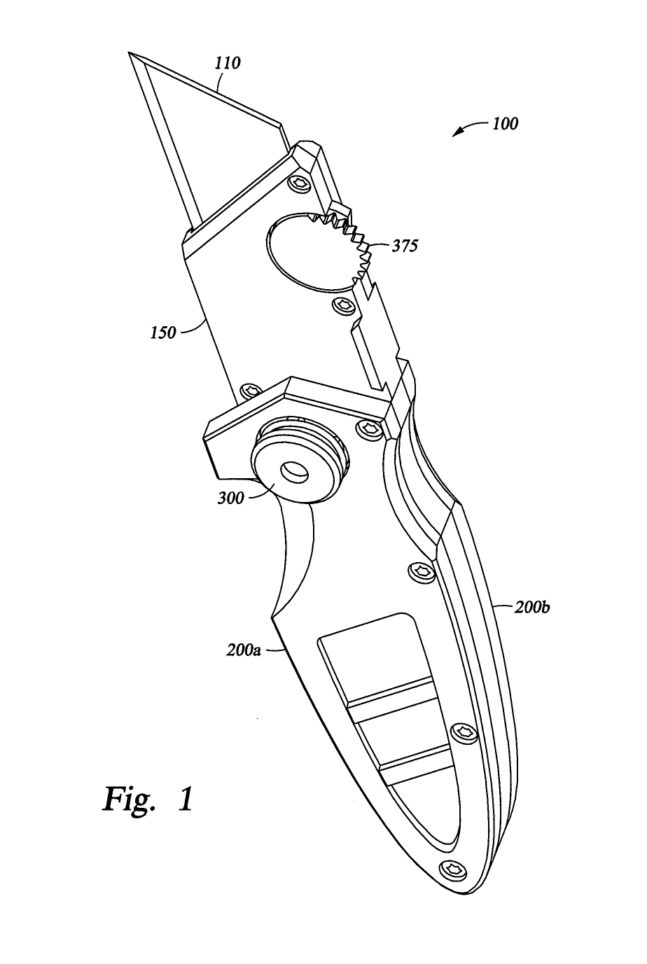

The present invention relates to a locking mechanism for a knife, wherein the blade and/or blade holder can be rotationally fixed at several locations relative to the knife handle. FIG. 1 is a perspective view illustrating a knife 100 having a locking mechanism according to one aspect of the invention. The knife of FIG. 1 is a utility knife wherein a blade 110 is disposed in a blade holder 150 and the assembly, including the blade holder moves between an open and closed position about a pivot point located in the handle of the knife. The knife 100 comprises a handle having a first 200a and second 200b portion, a blade holder 150 and a lock button 300 extending through the handle portions as well as the blade holder. Included in the embodiment is a rotating member 375 used to facilitate the removal and installation of a blade 110 into and out of the blade holder 150.

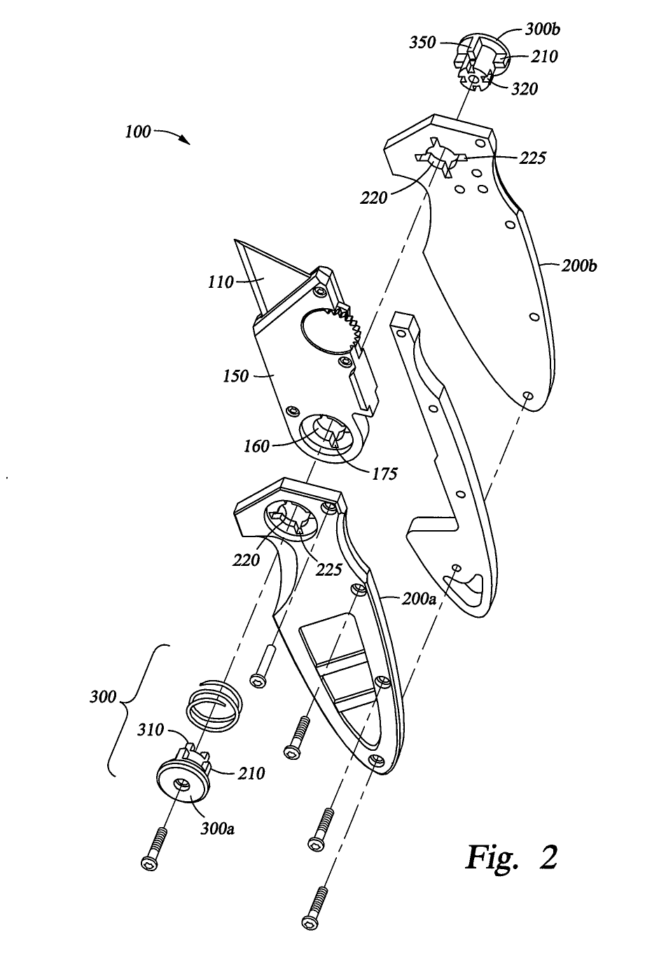

FIG. 2 is an exploded view of the knife 100 of FIG. 1 illustrating the relationship between the handle portions 200a, 200b, the blade and blade holder 150 and the lock button 300. In the embodiment shown, a central handle portion 205 fits between the outer handle portions 200a, b but does not form a part of the locking mechanism. The lock button 300 is a two-piece 300a, 300b assembly which extends through the blade holder 150 and handle portions 200a, b. The two pieces of the lock button fit together with button locking formations and button locking slots which cause both portions of the lock button to be rotationally fixed to one another. Additionally, handle locking formations formed on an exterior of the lock button mate with handle locking grooves formed in an aperture of the handle portions to rotationally fix the lock button to the handle. Finally, a blade locking formation formed on the second portion 300b of the lock button selectively interacts with one of a plurality of blade locking grooves extending from an aperture in the blade holder, thereby rotationally fixing the blade holder relative to the handle. The forgoing aspects of the knife 100 will be discussed and disclosed in greater detail below.

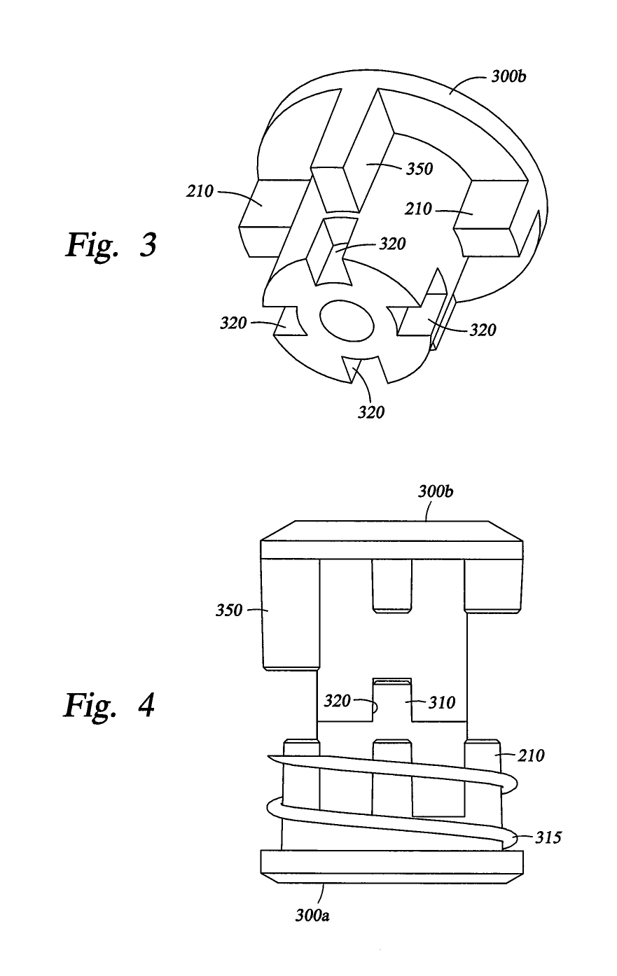

FIG. 3 is an enlarged view of the second portion 300b of the lock button and FIG. 4 is a top view of the assembled lock button showing the first and second portions 300a-b but not showing the handle portions or the blade holder which would be housed between the button portions. As illustrated in FIGS. 2-4, first portion 300a of the lock button includes button locking formations 310 constructed and arranged to mate with button locking slots 320 formed in second portion 300b of the lock button 300. The interaction of the formations 310 and slots 320 prevents rotation between the button portions.

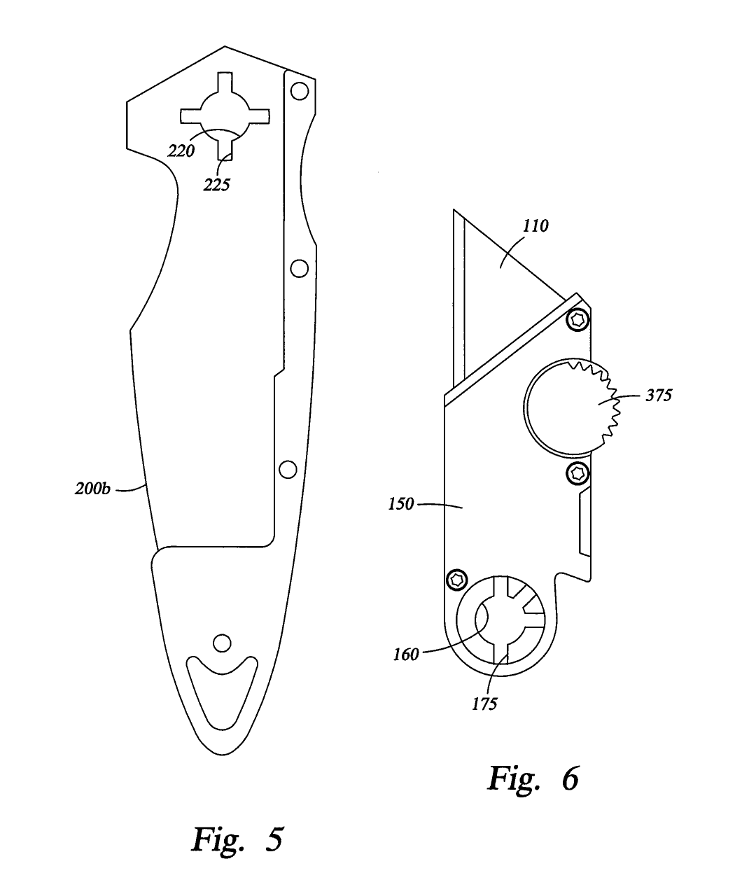

Also visible in FIGS. 2 and 3 are handle locking formations 210 formed on an outer surface of the first and second lock button portions. The purpose of the handle locking formations 210 is to rotationally fix the lock button 300 to the handle portions 200a, 200b. Visible in FIGS. 2 and 5, each handle portion includes an aperture 220 formed therein and four radially extending, handle locking grooves 225 extending from the aperture. When assembled, the formations 210 and grooves 225 between the lock button 300 and handle portions keeps the lock button rotationally fixed to the handle.

Visible in FIGS. 2 and 6 is an aperture 160 formed in the blade holder 150 of the knife 100. Extending from the aperture 160 are four blade locking grooves 175 disposed around a perimeter of the aperture in a way intended to correspond to certain pivotal/angular relationships between the blade holder 150 and the handle. The blade locking grooves 175 are constructed and arranged to selectively engage a blade locking formation 350 which is formed on the second portion 300b of the lock button 300. The blade locking formation is visible in FIGS. 2-4 and appears similar in shape to the handle locking formations 210 formed on the lock button. However, the blade locking formation is longer than the other formations permitting it to extend through handle portion 200a to the blade holder 150 and into contact with a selected blade locking groove 175.

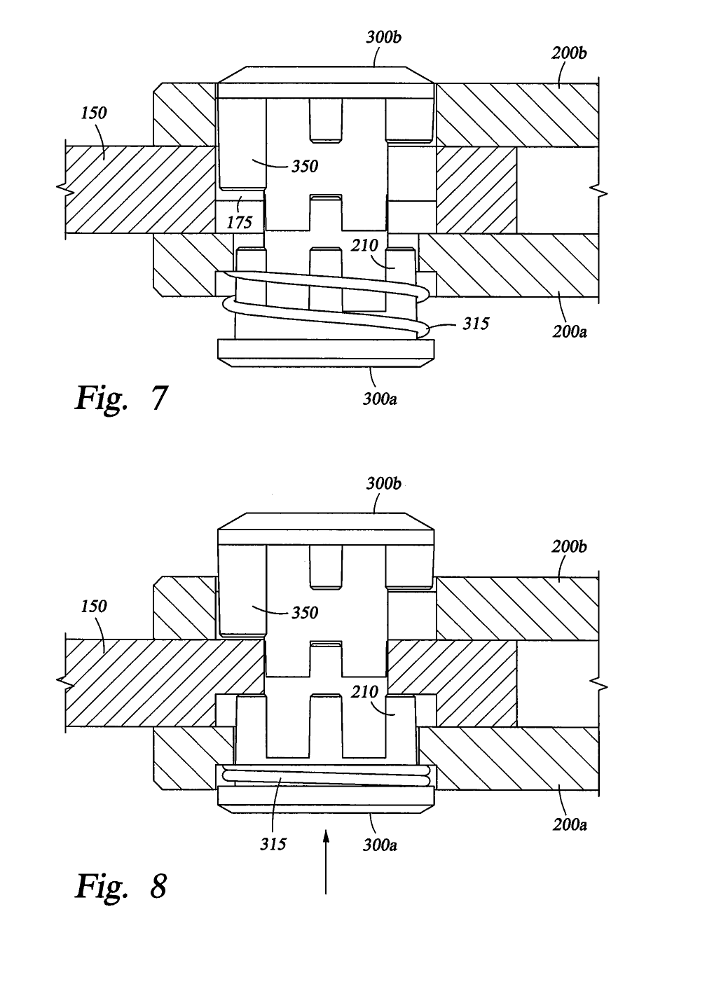

As illustrated in FIGS. 7 and 8, the blade locking formation 350 is normally biased into a position of interference with one of the blade locking grooves 175 (as it appears in FIG. 7) due to a spring member 315 disposed on the first portion 300a of the lock button 300 that urges the blade locking formation 350 into the area of the blade holder and, if it is aligned with a blade locking groove 175, into the groove where it will lock the blade holder and blade in a predetermined rotational position relative to the handle. As illustrated in FIG. 7, the blade locking formation 350 is located in one of the blade locking grooves 175 of the blade holder and remains held in that position due to the spring member which urges the lock button 300 towards one side of the knife handle.

FIG. 8 is a section view of the knife of FIG. 7 with the blade holder in an unlocked position and free to rotate about a pivot point at lock button 300 due to the retracted position of the blade locking formation 350. In FIG. 8, the lock button 300 is in a depressed position whereby the spring 315 is compressed and the lock button 300 is moved in a direction perpendicular to the long axis of the knife whereby the blade locking formation 350 is displaced from the area of the blade holder 150 and its blade locking grooves 175. The blade holder in this position is free to be rotated relative to the handle. In operation, the lock button 300 is depressed by a user against the spring 310 and the blade holder 150 can then be adjusted to a variety of positions and then, when the button is released, locked in that position due to the blade locking formation's engagement with a given blade locking groove 175.

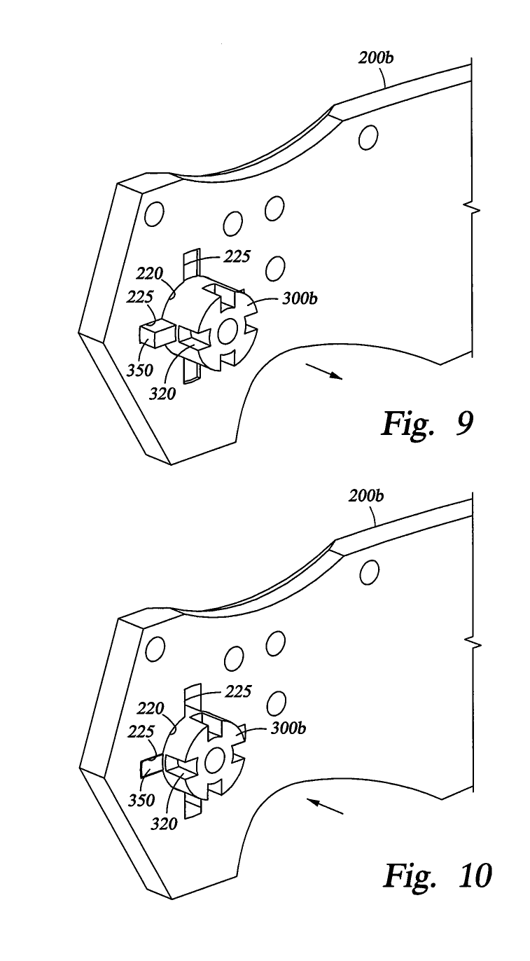

FIGS. 9 and 10 are two views that specifically illustrate the operation of the lock button 300 when it is operated by a user and the selective location of the blade locking formation 350 relative to the blade holder 150 (not shown). Each figure shows the inner surface of handle portion 200a and the second portion 300b of the lock button 300 located within the aperture 220 formed in the handle portion. FIG. 9 specifically illustrates the blade locking formation 350 in a position whereby it would extend into a blade locking grove 175 of the blade holder 150, thereby locking the blade holder 150 in a predetermined rotational position related to the handle. In FIG. 10, the same operational parts of the knife are shown as they would appear when the lock button 300 is depressed against the spring 315 and the blade locking formation 350 is displaced into a groove 225 of the handle portion 200a and away from the blade holder and the blade locking grooves 175.

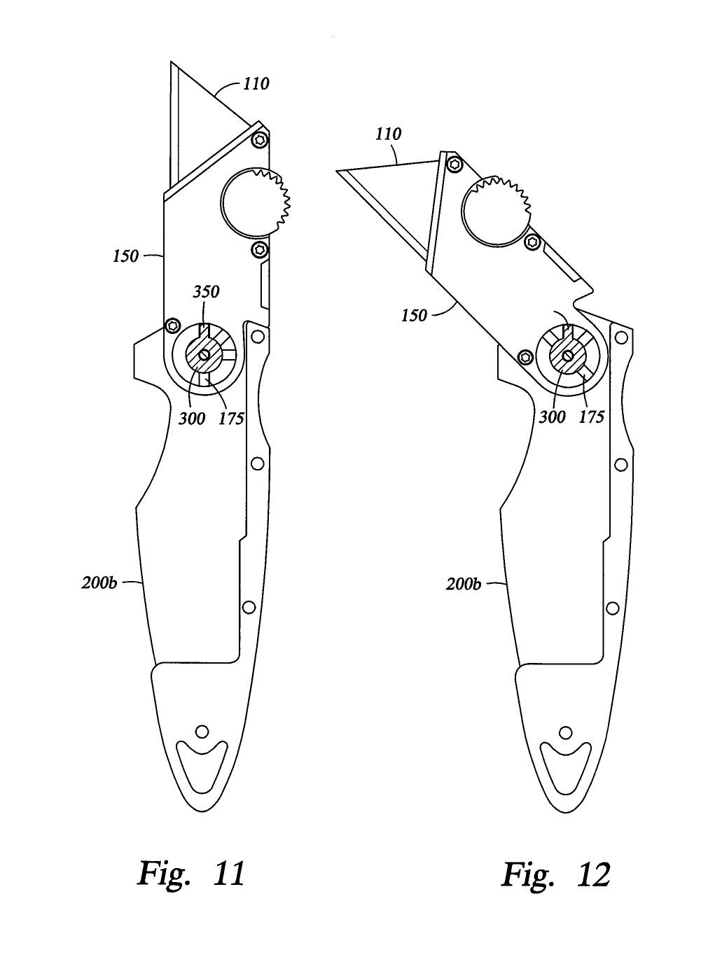

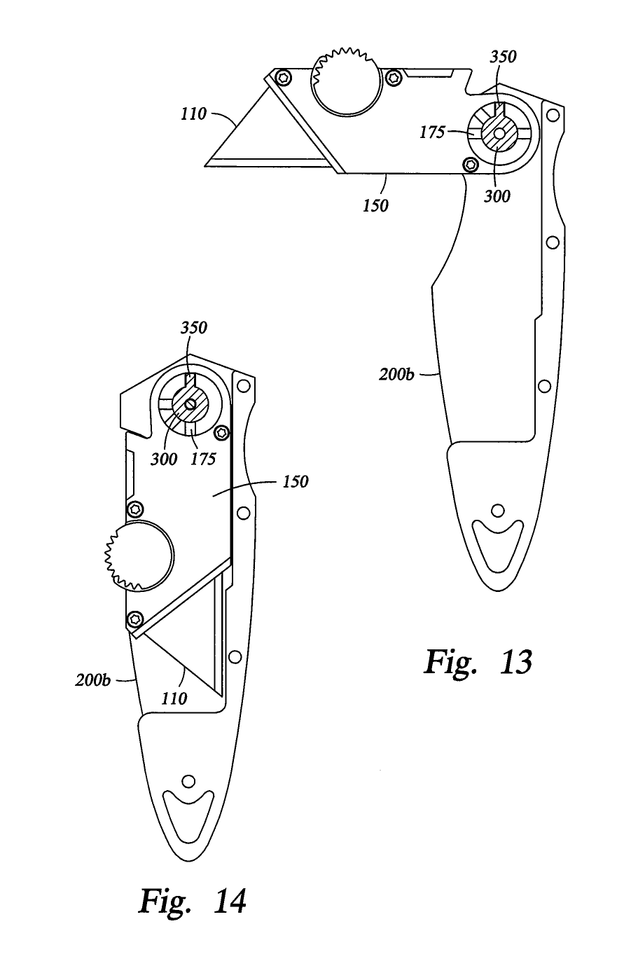

Various locked positions of the blade relative to the knife handle are illustrated in FIGS. 11 through 14. Each position relates to a position of the blade locking formation 350 in one of the blade locking grooves 175. For example, FIG. 12 illustrates the blade holder and blade locked an intermediate position between fully opened and fully closed. A user might lock the knife in the position to perform certain cutting jobs. To move the blade to another position, the lock button 300 is depressed and the blade holder 150 is free to move to another location where it will be locked at an angle relative to the handle due to the locking formation's movement into a particular blade locking groove 175 when the lock button 300 is released.

While the knife described in detail herein is a utility knife with a blade holder, the locking mechanism described and claimed is equally usable with any knife having a folding blade with a pivot point between the blade and the handle. Or instance, the aperture and blade locking grooves referred to in the blade holder could just as easily be formed directly in a first end of a blade.

While the foregoing is directed to embodiments of the present invention, other and further embodiments of the invention may be devised without departing from the basic scope thereof, and the scope thereof is determined by the claims that follow.

1. A knife with a locking mechanism:
a handle;
a blade;
a blade holder retaining the blade;
a locking mechanism including a lock button, the lock button extending through the handle and blade holder to form a pivot point between the handle and blade holder; and
the locking mechanism further providing at least two selective locking positions between the blade holder and the handle.

2. The knife of claim 1, wherein the handle is a two portion handle, the blade holder housed between the portions of the handle and the lock button extending through both portions.

3. The knife of claim 2, wherein the lock button is rotationally fixed to the handle

4. The knife of claim 3, wherein the lock button includes at least one handle locking formation formed thereon, the formation engagable with at least one handle locking groove formed in each the handle portion to rotationally fix the lock button to the handle.

5. The knife of claim 4, wherein a plurality of handle locking formations are equally spaced around the lock button and a plurality of handle locking grooves are equally spaced around an aperture formed in each handle portion.

6. The knife of claim 4, wherein the selective locking positions are provided by at least one blade locking formation formed on the lock button at least two blade locking grooves formed in the blade holder, the locking formation constructed and arranged to selectively engage one of the locking grooves, thereby rotationally locking the blade and blade holder in a position corresponding to the location of the locking groove in the blade holder.

7. The knife of claim 6, wherein the lock button includes two positions, a first position wherein the blade locking formation is engaged with a blade locking groove and a second position wherein the blade locking formation is displaced from the blade holder and the grooves.

8. The knife of claim 7, wherein the lock button is biased towards the first position.

9. The knife of claim 8, wherein the lock button is movable to the second position by a user.

10. The knife of claim 9, wherein a first the lock button portion includes a plurality of button locking formations disposed around a perimeter thereof and a second button portion includes a plurality of button locking slots, the formations and slots matable to prevent rotation between the first and second button portions.

11. The knife of claim 1, wherein the selective locking positions include a closed position, a fully open position and at least one intermediate position between opened and closed.

12. A method of operating a knife, the method including:
depressing a spring-biased lock button on a first side of the knife, thereby causing a blade locking formation to be displaced from engagement with a first blade locking groove in a blade holder;
rotating a the blade holder from a first rotational position relative to a handle, to a second rotational position relative to the handle whereby, in the second rotational position, the blade locking formation becomes engaged with a second blade locking groove.

13. The method of claim 12, wherein the first rotational position is either a fully opened or closed position and the second rotational position is a position therebetween.

14. A utility knife comprising:
a handle and a blade that pivots in respect to the handle between an opened and a closed position; and
a locking mechanism between the handle and the blade, the locking mechanism providing a pivot point between blade and handle and at least two locking positions relating to a rotational position of the blade holder relative to the handle.

15. A utility knife comprising:
a handle;
a utility blade having a cutting edge;
a blade holder for retaining the utility blade, the blade holder moveable with respect to the handle about a pivot point between a closed position and an operative position, wherein a distance from the pivot point to a forward-most point of the blade holder in a line parallel to the cutting edge of the utility blade is L₁; and
a locking mechanism mounted on the blade holder, the locking mechanism configured to removably retain the blade to the blade holder, the locking mechanism having a protrusion extending from a surface of the blade holder, wherein the shortest distance from the pivot point to the protrusion in a line parallel to the cutting edge of the utility blade is L₂, wherein L₂ is at least 50% of L₁.

16. A utility knife comprising:
a handle having a length of L₁;
a utility blade having a cutting edge;
a blade holder for retaining the utility blade, the blade holder moveable with respect to the handle about a pivot point between a closed position and an operative position; and
a locking mechanism mounted on the blade holder, the locking mechanism configured to removably retain the blade to the blade holder, the locking mechanism having a protrusion extending from a surface of the blade holder, wherein the shortest distance from the pivot point to the protrusion in a line parallel to the cutting edge of the utility blade is L₂, wherein L₂ is at least 20% of L₁.
